(19) United States
(12) Patent Application Publication
(10) Pub. No.: US 2026/0161813 A1
(43) Pub. Date: Jun. 11, 2026

(54) METHODS AND SYSTEMS FOR SECURELY SHARING DIGITAL DOCUMENTS

(71) Applicant: The Toronto-Dominion Bank, Toronto (CA)

(72) Inventors: Theresa Maria Gerth, Waterloo (CA); Vahid Amiri, King City (CA); Christopher Joseph Di Caro, Aurora (CA); Garrett BOND, Mississauga (CA); Grace Amy CHAN, Woodbridge (CA)

(21) Appl. No.: 18/970,703

(22) Filed: Dec. 5, 2024

(51) Int. Cl. G06F 21/62; G06F 21/31

(52) U.S. Cl. CPC G06F 21/6218; G06F 21/31

(57) ABSTRACT

Methods and system for sharing digital documents. The systems include: a first system comprising: a digital vault for storing one or more digital documents, and a digital vault portal that provides access to the digital vault; a second system that is separate and distinct from the first system; and an interface component that interfaces between the first system and the second system to provide access to the digital vault from the second system.

### TECHNICAL FIELD

The disclosed example embodiments relate to computer-implemented methods and systems for securely sharing digital documents.

### BACKGROUND

There are many situations where it is desirable for parties to be able to securely share digital documents (e.g., digital documents that comprise sensitive information (e.g., personally identifiable information or “PII”)). For example, a physician may wish to provide patients with their medical records and/or test results; or a manufacturer and supplier may wish to exchange purchase orders, invoices and shipping documents etc.

One known method for securely sharing digital documents is secure email exchange. However, secure email exchange systems are cumbersome to implement, have limited capabilities, and do not allow long-term storage of shared documents.

### SUMMARY

The following summary is intended to introduce the reader to various aspects of the detailed description, but not to define or delimit any invention.

A first aspect provides a computing system for sharing digital documents, the system comprising: a first system comprising: a digital vault for storing one or more digital documents, and a digital vault portal that provides access to the digital vault; a second system that is separate and distinct from the first system; and an interface component that interfaces between the first system and the second system to provide access to the digital vault from the second system.

The interface component may be configured to: receive, via the second system, a request to create the digital vault; and in response to receiving the request to create the digital vault, cause the first system to create the digital vault.

The interface component may be configured to, prior to causing the first system to create the digital vault, obtain a unique identifier from a third system, and causing the first system to create the digital vault comprises causing the first system to associate the digital vault with the unique identifier.

The digital vault portal may be configured to: receive a request to access the digital vault; and in response to receiving the request to access the digital vault: request login credentials, receive login credentials in response to the request, send the received login credentials to the third system, in response to the login credentials being verified by the third system, receive, from the third system, the unique identifier, and identify the digital vault from the unique identifier.

The system may further comprise the third system.

The third system may be an enterprise computing environment.

The digital vault may be associated with an entity, and the interface component may be configured to, prior to causing the first system to create the digital vault, cause the third system to record that the entity is associated with the digital vault.

The interface component may be configured to cause the third system to record that the entity is associated with the digital vault by interacting with one or more application programming interfaces of the third system.

Causing the first system to create the digital vault may comprise obtaining information from the second system associated with the digital vault and causing the first system to associate the digital vault with the information from the second system.

The interface component may be configured to: receive, via the second system, a request to access the digital vault, the request comprising the information from the second system associated with the digital vault, and send the information from the second system associated with the digital vault to the first system; and the first system may be configured to: identify the digital vault based on the received information from the second system associated with the digital vault, and send the interface component information identifying the one or more digital documents in the digital vault.

The second system may be configured to grant a requestor access to a record in the second system associated with the digital vault if the requestor has a first set of permissions, and grant the requestor access to the digital vault, via the interface component, only if the requestor has the first set of permissions and a second set of permissions.

The requestor may be deemed to have the second set of permissions if the requestor belongs to one of one or more predetermined active directory groups.

The second system may be configured to grant the requestor access to the second system after the requestor has been authenticated by an authentication system in a third system, and in response to authenticating the requestor, the authentication system is configured to provide the second system with a list of active directory groups to which the requestor belongs.

The requestor may be deemed to have the first set of permissions if the requestor is assigned, in the second system, a registered representative code that is associated with the record.

The first system may comprise one or more application programming interfaces (APIs) and the interface component may be configured to interact with at least one of the one or more APIs to provide access to the digital vault from the second system.

The first system may be a digital vault enterprise system, the second system may be a Salesforce system, and the interface component may be a lightening web component.

The second system may be configured to generate a digital document and, in response to receiving a request to upload the digital document to the digital vault, upload the digital document to the digital vault via the interface component.

The interface component may be configured to receive, via the second system, a request for an entity associated with the digital vault to upload a digital document to the digital vault, and in response to receiving the request, cause the first system to notify the entity of the request.

A second aspect provides a method of sharing digital documents, the method executed in a computing system, and the method comprising: maintaining, at a first system in the computing system, a digital vault that comprises one or more digital documents; providing, at the first system, a digital vault portal for accessing the digital vault; and providing, from a second system of the computing system that is separate and distinct from the first system, access to the digital vault via an interface component that interfaces between the first system and the second system.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a block diagram of an example system for sharing digital documents using a digital vault;

FIGS. 2A, 2B and 2C are message flow diagrams illustrating example messages for creating a digital vault in the first system of FIG. 1 from the second system of FIG. 1;

FIGS. 3A, 3B and 3C are message flow diagrams illustrating example messages for accessing a digital vault in the first system of FIG. 1 from the digital vault portal of FIG. 1;

FIG. 4 is a message flow diagram illustrating example messages for accessing a digital vault in the first system of FIG. 1 from the second system of FIG. 1;

FIG. 5 is a flow diagram of an example method for sharing digital documents using a digital vault;

FIG. 6 is a flow diagram of an example method for creating a digital vault in a first system from a second system;

FIG. 7 is a flow diagram of an example method for accessing a digital vault in a first system from a second system;

FIG. 8 is a flow diagram of an example method for accessing a digital vault in a first system from a digital vault portal in the first system using credentials for a third system;

FIG. 9 is a block diagram of an example computer which may be used to implement all or a portion of the system of FIG. 1 and/or execute all or a portion of the method of FIG. 5, the method of FIG. 6, the method of FIG. 7 and/or the method of FIG. 8;

FIG. 10 is a schematic diagram of an example graphical user interface presented by the second system and the interface component when a selected entity is not associated with a digital vault;

FIG. 11 is a schematic diagram of an example login screen which may be presented to an entity when they attempt to access their digital vault;

FIG. 12 is a schematic diagram of an example graphical user interface presented by the second system and the interface component when a selected entity is associated with a digital vault and a user of the second system has indicated they wish to access the digital vault;

FIG. 13 is a schematic diagram of the graphical user interfaces of FIG. 12 after the user has selected the “Folders” option;

FIG. 14 is a schematic diagram of the graphical user interface of FIG. 10 when a selected entity is associated with a digital vault;

FIG. 15 is a schematic diagram of the graphical user interface of FIG. 14 after the user has selected the “PIA” drawer;

FIG. 16 is a schematic diagram of an upload interface which may be presented to a user of the second system after they have indicated that they wish to upload a digital document to a digital vault; and

FIG. 17 is a schematic diagram of the upload interface of FIG. 16 when the user is selecting the type of digital document to upload.

### DETAILED DESCRIPTION

Described herein are methods and systems for securely sharing digital documents using digital vaults. A digital vault, which may also be referred to as an electronic vault, is a secure online storage system for storing digital documents and/or other digital data. The documents and data in a digital vault are typically kept secure through a variety of techniques such as, but not limited to, storing the documents and data in encrypted form; and controlling or restricting access to the digital vault so that only authorized users can access the documents and other data in a digital vault. For example, a user may only be granted access to a digital vault after they have been authenticated by, for example, a multi-factor authentication process and/or biometric authentication. Accordingly, a digital vault is akin to a virtual safe for digital documents and/or data. Digital vaults can be used for secure document sharing by, for example, granting multiple users access to the same digital vault.

Generally, a digital vault is established and maintained by a digital vault enterprise or provider (e.g., SideDrawer™) and users can directly access the digital vault via the digital vault enterprise (e.g., SideDrawer™) system comprising the digital vault. However, it may be desirable for an enterprise that shares digital documents with their clients via a digital vault to be able to access the digital vault from applications or systems within the enterprise's computing environment which the enterprise already uses to generate and maintain data and documents for its clients. For example, an enterprise may provide one or more services to clients via a special system or platform, such as, but not limited to, Salesforce™, which is used manage their client's accounts, relationships and opportunities. It may be advantageous in such cases to be able to access a client's digital vault directly from Salesforce™. Being able to access and interact with a digital vault from such an external system (i.e., a system external to the digital vault enterprise system) would negate the need to export documents from that external system to an intermediary location and then login to the digital vault enterprise system and import the exported documents into the digital vault. Being able to access and interact with a digital vault from such an external system may also allow all the documents and data related to a client to be accessible from a single system.

Accordingly, described herein are methods and systems for sharing digital documents using a digital vault in a first system that can be accessed directly from the first system or indirectly from a second system via an interface component. Specifically, the systems described herein comprise a first system comprising a digital vault for storing digital documents, and a digital vault portal for providing access to the digital vault; and a second system, which is separate and distinct from the first system, which provides access to the digital vault via an interface component that interfaces between the first system and the second system.

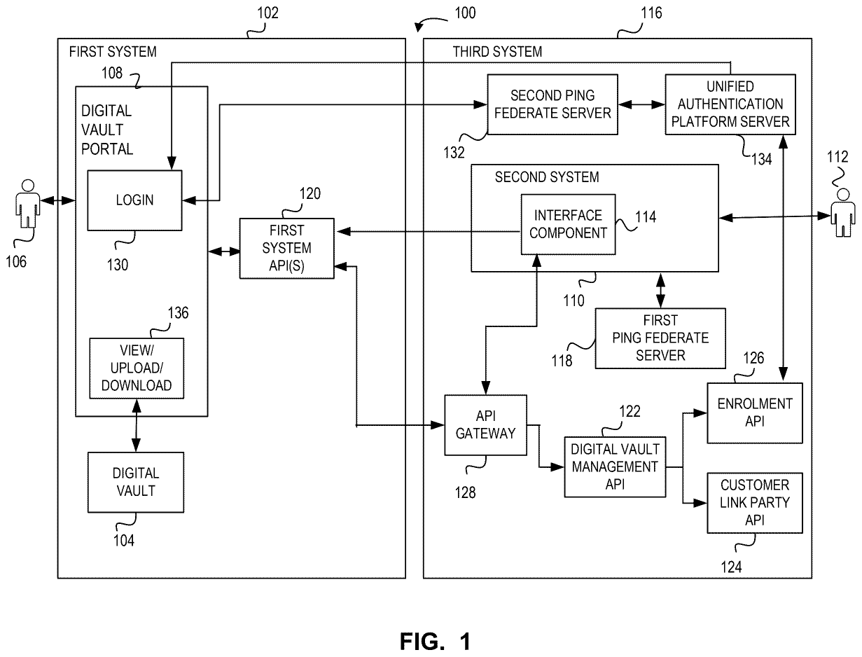

Reference is now made to FIG. 1 which illustrates an example system 100 for sharing digital documents using a digital vault. The system 100 comprises a first system 102 that comprise a digital vault 104 for an entity 106 and the entity 106 can access the digital vault 104 via the first system 102 (e.g., via a digital vault portal 108 of the first system 102); and a second system 110 that is separate and distinct from the first system 102, and a user 112 of the second system 110 can access the digital vault 104 from the second system 110 via an interface component 114.

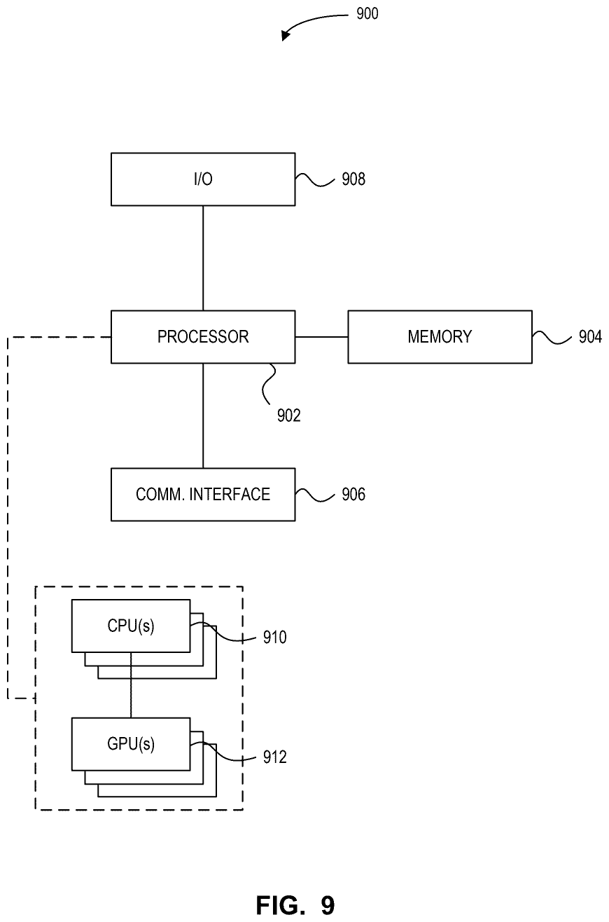

The first system 102 is a computing system comprising a set of one or more computers, such as, but not limited to the computer 900 described with respect to FIG. 9, that is configured to maintain, and provide access to, one or more digital vaults 104. As described above, a digital vault is a secure online storage system for storing digital documents and/or other digital data. In some cases, one or more of the digital vaults 104 may have a hierarchical structure. For example, one or more of the digital vaults may have one or more drawers, each drawer may comprise one or more tiles, each tile may comprise one or more records, and each record may comprise one or more digital documents. Accordingly, the first system 102 is capable of securely receiving and storing digital documents and/or other data.

The second system 110 is a computing system comprising a set of one or more computers, such as, but not limited to the computer 900, described with respect to FIG. 9, that is configured to maintain a record for each of one or more entities 106 (e.g., clients). Each record may comprise, for example, information and/or digital documents related to the associated entity (e.g., client). Users 112 of the second system 110 may be able to view and/or manipulate the records thereof. For example, a user 112 of the second system 110 may be able to create records, view records, and/or create documents which can be added to a record. In some cases, the second system 110 may provide a graphical user interface which users 112 can interact with to view and/or manipulate the records in the second system 110. In some cases, the second system 110 may be a system, such as, but not limited to, a Salesforce™ system which is used to manage client accounts, relationships and opportunities. However, this is just an example, and the second system 110 may be any system that maintains records for one or more entities.

In the system 100 of FIG. 1, one or more of the entities 106 (e.g., clients) is associated with a digital vault 104 in the first system 102. Such a digital vault 104 is designed to allow the entity 106 (e.g., client) and users 112 of the second system 110 to share digital documents in a secure manner.

An entity 106 (e.g., client) may be able to access their digital vault 104 directly via the first system 102. For example, as shown in FIG. 1, the first system 102 may comprise a digital vault portal 108 which an entity 106 can use to access its digital vault 104. An entity 106 may be able view the contents of, upload digital documents to, view digital documents in, download digital documents from, deleted digital documents in, modify the metadata of digital documents in, and/or change the location of a digital document in, a digital vault 104 associated with the entity 106 via the digital vault portal 108. In some cases, an entity 106 may also be able to search for documents in a digital vault 104 associated with the entity 106 by, for example, name and/or replace a document in the digital vault associated with the entity 106 with an updated version using the digital vault portal 108. In some cases, an entity 106 may be able to access the digital vault portal 108 via a web browser. An example implementation of the digital vault portal 108 is described in more detail below. In some cases, the first system 102 may be implemented and maintained by a digital vault enterprise such as, but not limited to, SideDrawer™.

In contrast to the entities 106, the users 112 of the second system 110 may not access the digital vaults 104 directly from the first system 102. Instead, an interface component 114 is configured to interface between the first system 102 and the second system 110 to allow users 112 of the second system 110 to access digital vaults 104 in the first system 102 from the second system 110. Specifically, the interface component 114 is configured to receive requests, via the second system 110, to access or interact with a digital vault 104, send those requests to the first system 102, receive responses to those requests from the first system 102 and provide the responses to the second system 110. For example, the interface component 114 may allow a user 112 of the second system 110 to view the contents of, upload digital documents to, view digital documents in, download digital documents from, deleted digital documents in, modify the metadata of digital documents in, change the location of a digital document in, and/or request that an entity 106 upload digital documents to, a digital vault 104 associated with an entity 106. Where a user 112 deletes a digital document from a digital vault 104, the user 112 may, for auditing purposes, be asked to provide a reason from a predetermined list of reasons for deleting the digital document. In some cases, the interface component 114 may also allow a user 112 of the second system 110 to search for documents in a digital vault 104 associated with an entity 106 by, for example, name and/or replace a document in the digital vault 104 associated with an entity 106 with an updated version.

In some cases, as shown in FIG. 1, the interface component 114 may be integrated with the second system 110. In other cases, the interface component 114 may be external to, and in communication with, the second system 110. In some cases, the interface component 114 may be configured to provide, within the second system 110, a graphical user interface which a user 112 can use to access and interact with a digital vault associated with an entity 106.

In some cases, the interface component 114 may be implemented by a software widget. A software widget is a small application that can be added to an application to add specific functionalities or information. When the second system 110 is a Salesforce™ system, the interface component 114 may be a lightning web component (LWC). LWCs are custom Salesforce™ components that can be configured to create custom pages and functions in a Salesforce™ platform. However, this is just an example, and the interface component 114 may be any suitable component that can interface between the first system 102 (e.g., a digital vault enterprise system) and the second system 110.

Enabling users 112 of the second system 110 to access and interact with a digital vault 104 from the second system 110 allows all the documents and data related to an entity 106 (e.g., client) to be accessible from a single system increasing the efficiency of the system. In addition, where the second system 110 can be used to generate documents which are to be securely shared with an entity 106, enabling users 112 of the second system 110 to access and interact with a digital vault 104 from the second system 110 negates the need to export documents from the second system 110 to an intermediary location and then login to the first system (e.g., digital vault enterprise system) and upload the exported documents into the digital vault 104. This can make the digital document sharing more secure.

In some cases, as shown in FIG. 1, the second system 110 may form part of, or be affiliated with, a third system 116. For example, in some cases, the third system 116 may be an enterprise computing environment for an enterprise that provides one or more services and/or products to clients or customers. In such cases, the second system 110 may be used to provide one of the one or more services and/or products to clients. In such cases, the entities of the second system 110 may be clients of the enterprise and the users of the second system 110 may be employees of the enterprise; and the enterprise may comprise a master record for each client and the record in the second system for a client may be tied to the client's master record in the third system 116. For example, the enterprise may be a financial institution that provides financial services and products to clients including, but not limited to, wealth management advice; and the wealth management advice may be provided via the second system 110 (e.g., a Salesforce™ system). In such an example, the digital vault 104 associated with a client may be used to provide the client with a document setting out a summary of their financial investments, or for the client to provide tax slips etc.

### User Access to Digital Vault via Interface Component

In some cases, a user 112 may be able to login to the second system 110 using credentials associated with the third system 116. For example, where the third system 116 is an enterprise computing system and the user 112 is an employee of the enterprise, the user 112 may be able to login to the second system 110 with their employee credentials.

In such cases, when a user 112 attempts to access the second system 110, an authentication request may be sent to a first ping federate server 118 of the third system 116, which may be referred to as an internal or employee ping federate server. A ping federate server allows enterprises to securely share identity information, to provide single sign on (SSO). In other words, a ping federate server allows services provided by one enterprise to be accessed by authentication provided by another enterprise. In response to receiving the authentication request, the first ping federate server 118 may forward the request to an authentication server (not shown) within the third system 116. The authentication server may ask the user 112 to enter their credentials (e.g., employee credentials) for the third system 116. The authentication server may then authenticate the employee based on the provided credentials.

Once the user 112 has logged into the second system 110, the user 112 may be able to access one or more records maintained by the second system 110. In some cases, the user 112 may only be able to access a subset of the records in the second system 110. Specifically, in some cases, the user 112 may only be able to access records that the user 112 is associated with. In one example, each record may be associated with a client of the third system 116 and each client may be associated with a Registered Representative (RR) code which identifies a user of the third system 116 or a set of users of the third system 116 that are assigned to the client. In such cases, the user 112 may only have access to records that have an RR code that is associated with the user 112.

However, in some cases, even if the user 112 has access to a record (e.g., based on the client's RR code), the user 112 may only be able access the digital vault associated with that record if the user 112 is also authorized to access digital vaults. In other words, in these cases, digital vault access or permission may be a separate from record access or permission. This allows digital vault access to be restricted to only those users that require access—i.e., it allows more granular access control to digital vaults.

In some cases, a user 112 may only be able to access digital vaults if the user 112 belongs to an active directory (AD) group that has been granted digital vault access. AD is a directory service for a Windows™ environment. In these examples, the user's AD group membership in the third system 116 may be provided to the second system 110 when the user logs in (e.g., is authenticated by the authentication server in the third system 116).

### Generating a Digital Vault for an Entity

In some cases, a user 112 of the second system 110 may be able to create a digital vault 104 for an entity 106 from the second system 110. Specifically, if the user 112 has digital vault access (as described above), the user 112 may be able to, via the second system 110, indicate that a digital vault is to be created for the entity 106. In response to such an indication, the interface component 114 may then interact with the first system 102 (e.g., the digital vault enterprise system) to cause the digital vault 104 to be created.

For example, a user 112 may login to the second system 110 and access (e.g., via a graphical user interface (GUI) provided by the second system 110) the record for an entity 106. In some cases, the user 112 may be able to access the record for an entity 106 by searching for the entity in a list of entities and selecting the entity 106. Once the user 112 has accessed the entity's record, if the user 112 is authorized to access digital vaults (as described above), the interface component 114 may provide the user 112 with the option to create a digital vault for the entity 106 (if the entity 106 does not already have one). For example, in some cases, once an entity's record in the second system 110 has been accessed, the interface component may present a “Digital Vault” link or tab that the user can click on or otherwise activate to indicate that the user wishes to access the entity's digital vault. If the user does not have a digital vault the interface component may present the user with the means (e.g., a button or the link) for indicating that they wish to create a digital vault for the user.

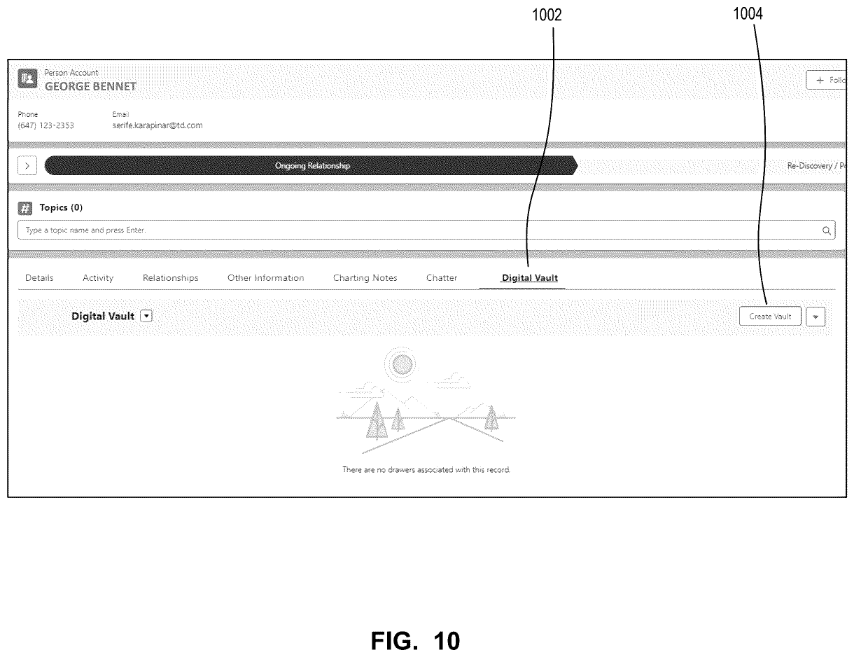

For example, FIG. 10 illustrates an example graphical user interface which may be presented by the second system 110 and the interface component 114 after the user has selected an entity (“George Bennet”) record in the second system and indicated that they wish to access George Bennet's digital vault. Specifically, the graphical user interface has a “Digital Vault” selection 1002 which has been added by the interface component which, when activated by the user of the second system, indicates to the interface component 114 that the user wishes to access the selected entity's digital vault. In the example shown in FIG. 10, the user has activated the “Digital Vault” selection 1002, but George Bennet is not yet associated with a digital vault, so the “Create Vault” button 1004 is displayed in the graphical user interface by the interface component. By clicking on the “Create Vault” button 1004 the user can indicate to the interface component that they wish to create a digital vault for the selected entity (e.g., “George Bennet”).

If the user 112 indicates that they wish to create a digital vault for the selected entity 106 (e.g., by clicking the button or link), then the interface component 114 interacts with the first system 102 (e.g., digital vault enterprise system) to cause a digital vault 104 to be created in the first system 102 for the entity 106. For example, the interface component 114 may send a create digital vault request to the first system 102 which causes the first system 102 to create the digital vault. In some cases, the interface component 114 may communicate with one or more application programming interfaces (APIs) 120 in the first system 102 to create the digital vault 104.

In some cases, the create digital vault request may comprise information from the second system 110 that is associated with the selected entity 106 (e.g., an identifier in the second system 110 for the selected entity 106). The first system 102 (e.g., digital vault enterprise system) may then associate the digital vault 104 with that information so as to link the entity's record in the second system 110 to the digital vault 104. As described in more detail below, this allows a user 112 of the second system 110 to access the digital vault 104 for the entity 106 using only information available in the second system 110 - e.g., by providing the first system (e.g., via the interface component) with the information from the second system 110 that is associated with the selected entity 106.

In some cases, where the second system 110 forms part of, or is affiliated with, a third system 116 (e.g., enterprise computing environment), the create digital vault request may also comprise information from the third system 116 that is associated with the entity. Specifically, as part of creating the digital vault for the entity the interface component 114 may provide the third system 116 with information (i) identifying the entity; and (ii) indicating that a digital vault is to be created for the entity. The third system 116 may then associate the entity 106, and specifically, the entity's credentials (e.g., login credentials) for the third system 116, with a unique identifier (e.g., an MBUN (meaningless but unique number)) and provide the unique identifier (e.g., MBUN) to the interface component 114. The first system 102 (e.g., digital vault enterprise system) may then associate the digital vault 104 with that information (e.g., unique identifier). The unique identifier (e.g., MBUN) thus links the entity's main record (and specifically their credentials thereof) in the third system 116 (e.g., enterprise computing environment) with the digital vault 104 in the first system 102 (e.g., digital vault enterprise system), without having to provide the first system 102 (e.g., digital vault enterprise system) with sensitive information (e.g., the enterprise's main entity identifier). As described in more detail below, this may allow the entity 106 to access their digital vault 104 using the entity's credentials for the third system 116. In other words, this may allow for single sign on (SSO).

In some cases, an entity 106 may have multiple credentials it can use to access the third system 116. For example, an entity 106 may have one set of credentials for accessing one service or product offered by an enterprise and another set of credentials for accessing a different service or product offered by the enterprise. In such cases, the third system 116 may be configured to generate a unique identifier (e.g., MBUN) for each set of credentials and all of the unique identifiers are provided to the first system 102 and associated with the digital vault for the entity 106. This allows the entity to access the digital vault using any of their third system credentials.

In some cases, a digital vault may only be created for an entity 106 if the entity 106 meets certain eligibility requirements. For example, in some case, a digital vault may only be created if the entity 106 has agreed to share information electronically, resides in a certain geographical location (e.g., Canada or North America), and/or has provided an email address by which they can be contacted. This is only an example of eligibility requirements and in other examples other eligibility requirements may be used. In such cases, the interface component 114 may first check, from the entity's record in the second system 110, that the eligibility requirements are met for the entity 106 before causing the first system 102 (e.g., digital vault enterprise system) to create the digital vault 104 for the entity 106.

In some cases, where the second system 110 forms part of, or is affiliated with, a third system 116 (e.g., enterprise computing environment), prior to causing the first system 102 (e.g., digital vault enterprise system) to create the digital vault 104 for the entity 106, the interface component 114 may first cause the entity 106 to be registered for a digital vault in the third system 116 (e.g., the enterprise computing environment). In some cases, the interface component 114 may cause an entity 106 to be registered for a digital vault in the third system 116 by interacting with one or more components in the third system 116 (e.g., the enterprise computing environment). For example, in some cases, the third system 116 may comprise one or more components, such as APIs 122, 124, 126, which can be accessed by the interface component 114 to register a user for a digital vault.

In one example, to register the entity 106 for a digital vault, the interface component 114 may send a digital vault registration request to a digital vault management API 122 in the third system 116 via an API gateway 128. The digital vault registration request includes information from the second system 110 associated with the entity 106 (e.g., an identifier for the entity 106 in the second system 110). The digital vault registration request may also include additional information about the entity such as birth date etc. The digital vault management API 122 may then obtain, using the information from the second system 110 that is associated with the entity 106, an identifier for the entity 106 in the third system 116 by calling or consuming a customer link (CL) party API 124.

Once the identifier for the entity 106 in the third system 116 has been obtained, an enrolment API 126 may be invoked by the interface component 114 to register the client for a digital vault. The enrolment API 126 uses the identifier in the third system 116 to update the entity's main record in the third system 116 (e.g., enterprise computing environment) to indicate that the entity 106 is registered for a digital vault. This may involve updating the entity's main record in the third system 116 (e.g., enterprise computing environment) to indicate that the client has subscribed to the digital vault service. For example, an entity's main record(s) in the third system 116 may comprise information indicating which services and products the entity is registered for and the entity's main record in the third system 116 may be updated to indicate that the entity is registered for a digital vault service.

In some cases, it may be the enrolment API 126 that is configured to generate the unique identifier(s) (e.g., MBUN) for the entity and (i) associate the unique identifier(s) with the entity's main record in the third system; and (ii) provide the unique identifier(s) to the interface component 114.

In some cases, once a digital vault 104 for the entity 106 has been created in the first system 102, the entity 106 may be notified (e.g., via email) by the first system 102 or the third system 116 that the digital vault 104 has been created. The entity 106 may also be provided with information on how to access the digital vault 104. For example, the entity 106 may be provided with a link to a webpage which the entity 106 can use to access the digital vault 104. In another example, the entity 106 may be provided with instructions on how to access the digital vault from within an enterprise portal provided to the entity.

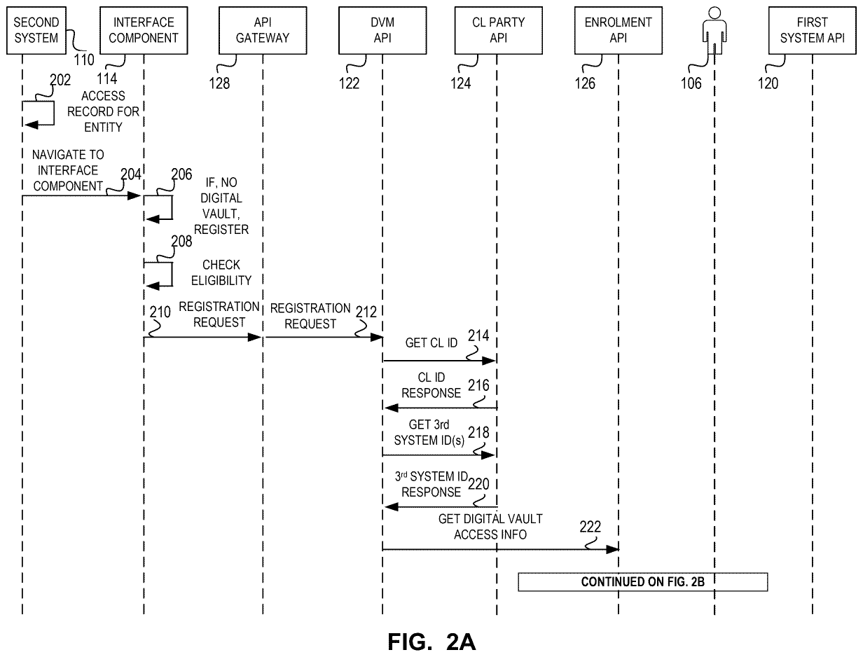

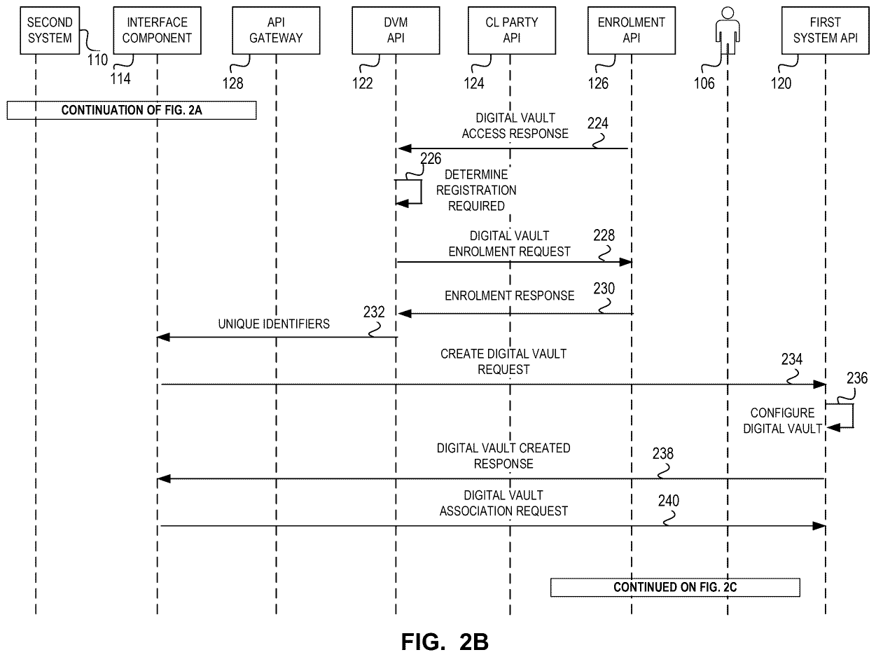

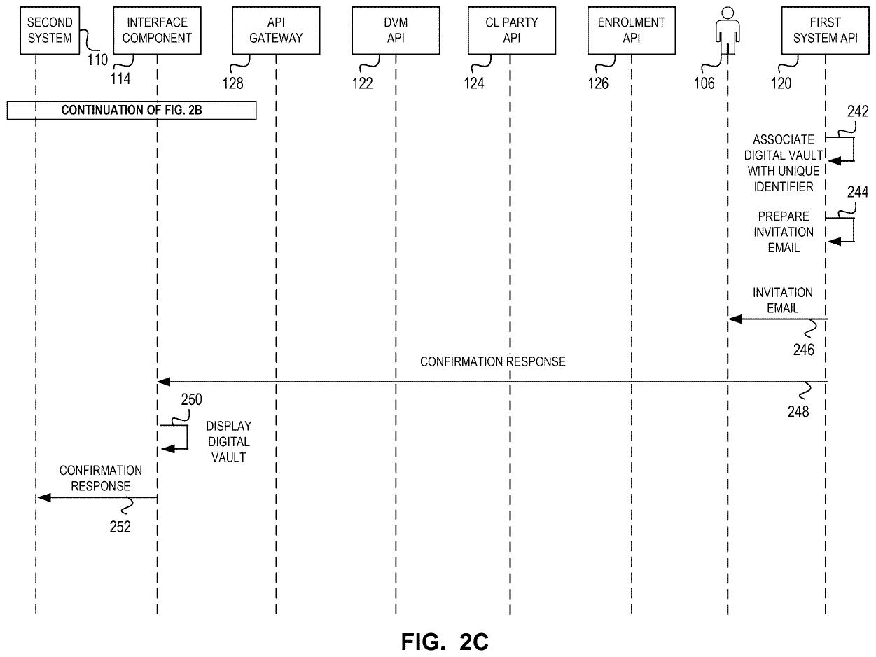

Reference is now made to FIGS. 2A, 2B and 2C which illustrate an example message flow for creating a digital vault 104 for an entity 106 from the second system 110. The process begins at 202 where a user 112 accesses the record in the second system 110 associated with the entity 106. As described above, the user 112 may access the record in the second system 110 associated with an entity 106 by performing a search in the second system 110 for the entity 106 and, once the entity 106 is located, selecting that entity 106. Once the user 112 has accessed the record in the second system 110 associated with the entity 106, the user 112, at 204, indicates that they wish to access the digital vault associated with the selected entity/record. In some cases, the interface component 114 may present a “Digital Vault” link or tab in a graphical user interface of the second system 110, and the user 112 may be able to indicate they wish to access the digital vault associated with the currently selected entity 106 by selecting or otherwise activating the “Digital Vault” link or tab. This invokes the interface component 114.

Then, at 206, the interface component 114 determines whether there is a digital vault associated with the selected entity 106. If it is determined that there is no digital vault associated with the entity 106, then, at 208, the interface component 114 determines whether the entity 106 is eligible for a digital vault. For example, as described above, a user may only be eligible for a digital vault if they meet one or more eligibility requirements. For example, a user may only be eligible for a digital vault if the user has agreed to share information with the enterprise electronically, resides in a certain geographical location (e.g., Canada or North America), and/or has provided the enterprise an email address by which they can be contacted. If it is determined that the entity 106 is eligible for a digital vault then the process of registering the entity for a digital vault is begun.

Specifically, at 210 and 212 the interface component 114 sends a digital vault registration request for the entity 106 to the digital vault management (DVM) API 122 via the API gateway 128. The digital vault registration request may include information identifying the entity such as, but not limited to, an identifier associated with the entity in the second system 110, their name and/or date of birth (DOB). Upon receiving the digital vault registration request, the digital vault management API 122, at 214, sends a get customer link (CL) ID request to the customer link party API 124. The get CL ID request comprises information identifying the entity 106 (e.g., one or more of the pieces of information identifying the entity 106 that was received in the registration request 212). Then, at 216, the customer link party API 124 sends a response to the get request that comprises the CL ID for the entity 106. The response may also comprise other information about or related to the entity 106. Upon receiving the CL ID response, the digital vault management API 122 may analyze the received CL ID to verify that it meets certain requirements (this step is not explicitly shown in FIGS. 2A-2C). For example, the digital vault management API 122 may be configured to determine if the CL results are unique. If the digital vault management API 122 determines that the CL results are not unique, the digital vault management API 122 may send an error message to the API gateway 128 which is forwarded to the interface component 114, or ask the user 112 to select which CL ID is the correct CL ID.

If, however, the digital vault management API 122 determines that the requirements are met for the CL results (e.g., the CL results are unique), or if the digital vault management API 122 does not analyze the CL results, the digital vault management API 122, at 218, sends a get request to the CL party API to retrieve the third system identifier(s) associated with the CL ID received at 216. The third system identifier may be an identifier that the entity can use to login to or access the third system. In other words, the third system identifier may form part of a set of credentials that the entity can use to login to or access the third system. The third system may provide a variety of different services etc. and may give an entity a different identifier (e.g., a different set of credentials) for each service, thus there may be multiple third system identifiers associated with each CL ID. In response to receiving the third system identifier request, the CL party API, at 220, sends a response to the digital vault management API 122 that includes a list of the third system identifiers associated with the CL ID provided in the get request. The response at 220 may also include other information associated with the entity or the third system identifier(s). In some cases, if the response at 220 does not comprise at least one third system identifier, then the digital vault management API 122 may be configured to send an error response or message (not shown) to the API gateway 128 which is forwarded to the interface component 114.

Once the digital vault management API 122 has received a third system ID response, at 220, with at least one third system identifier then, for each third system identifier, the digital vault management API 122 executes 222 and 224. Specifically, for each third system identifier received in the response, at 220, the digital vault management API 122 sends a get digital vault access request to the enrolment API 126. The get digital vault access request comprises information identifying a third system identifier and may optionally include additional information. In response to receiving a get digital vault access request, the enrolment API 126 is configured to determine whether the third system identifier is registered for a digital vault. In some cases, each third system identifier may be associated with a digital vault service code if the third system identifier is registered for a digital vault. In these cases, the enrolment API 126 may be configured to determine whether the third system identifier associated with a request is registered for a digital vault based on whether it is associated with a digital vault service code. Once the enrolment API 126 has determined whether the third system identifier is registered for a digital vault, the enrolment API 126, at 224, sends a digital vault access response which indicates the results of the determination (i.e., whether the third system identifier is associated with a digital vault).

Once the digital vault management API 122 has received a response (at 224) for each third system identifier, the digital vault management API 122 determines, at 226, whether the third system identifiers are to be registered for a digital vault. If the digital vault management API 122 determines that all of the third system identifiers are registered for a digital vault then the method may proceed directly to 232 where the enrolment API 16 provides the unique identifiers (e.g., MBUNs) associated with the third system identifiers to the interface component 114. If, the digital vault management API 122 determines that some, but not all, of the third system identifiers are registered for a digital vault then there is an error and an error message may be returned to the interface component 114. If, however, the digital vault management API 122 determines that none of the third system identifier(s) is/are registered for a digital vault, then steps 228 and 230 are repeated for each third system identifier. Specifically, the digital vault management API 122, at 228, sends a digital vault enrolment request which identifies the third system identifier. In response to receiving an enrolment request, the enrolment API 126 may record that the third system identifier is registered for a digital vault (e.g. associate the identifier with a digital vault service code), associate the third system identifier with a unique identifier (e.g. an MBUN (meaningless but unique number)) that can be used to link the digital vault with the third system identifier, and, at 230, send an enrolment response to the digital vault management API 122 that comprises the unique identifier.

In response to receiving the enrolment response(s), the digital vault management API 122, at 232, sends a message comprising the unique identifiers received in the enrolment response(s) to the interface component 114. The message may also comprise information about/identifying the entity 106 such as, but not limited to, the entity's name, date of birth and/or address. In response to receiving the message, the interface component 114, at 234, sends a create vault request to the first system 102 (e.g., the first system API 120). The create vault request may comprise information about the entity 106 that the vault is to be associated with such as, but not limited to, information identifying the entity's record in the second system 110, information about/identifying the entity such as, but not limited to, the entity's name, date of birth and/or address, the entity's email address, and information identifying the user 112 of the second system that initiated the creation of the digital vault. In response to receiving the create vault request, the first system 102 (e.g., first system API 120), at 236, creates and configures a new digital vault for the entity 106 and associates the digital vault with the information identifying the entity in the second system. Once the digital vault for the entity 106 has been created, the first system 102 (e.g., first system API 120), at 238, sends a vault created response to the interface component 114. The vault created response may comprise information identifying the digital vault (e.g., a digital vault identifier and/or a filing cabinet identifier). In some cases, for security purposes, the interface component 114 does not permanently store the information identifying the digital vault (e.g., the digital vault identifier and/or filing cabinet identifier) nor does the interface component 114 send the information identifying the digital vault to the second system 110.

In response to receiving the digital vault created response, the interface component 114, at 240, sends a digital vault association request to the first system 102 (e.g., the first system API 120) which requests that the first system 102 associate the new digital vault with the unique identifier received from the enrolment API (via the digital vault management API 122). The digital vault association request may comprise information identifying the digital vault (e.g., the digital vault identifier) and information identifying the unique identifier(s) (e.g., MBUN(s)). In response to receiving the digital vault association request, the first system 102 (e.g., first system API 120), at 242, associates the new digital vault with the received unique identifier(s) (e.g., MBUN(s)). As described above, associating the digital vault with the unique identifier, which is also associated with the entity's identifier in the third system, links the entity's main record in the third system 116 to the digital vault 104 without providing the first system 102 (e.g., digital vault enterprise system) with sensitive information from the third system (e.g., the third system's main identifier). As described in more detail below, this link may allow the entity 106 to access the digital vault 104 using their credentials for the third system 116. In other words, it may allow for single sign on (SSO).

Once the first system 102 (e.g., the first system API 120) has associated the new digital vault with the unique identifier(s) provided by the interface component 114, the first system 102 (e.g., the first system API 120), at 244, prepares an invitation email to the entity 106 to notify them of the creation of the digital vault. The invitation email may also comprise information on how the entity 106 can access the digital vault. Once the invitation email has been prepared then, at 246, the invitation email is sent to the entity 106. The first system 102 (e.g., the first system API 120) may, at 248, send a confirmation response to the interface component 114 to confirm that the digital vault for the entity 106 has been set up and that the entity 106 has been notified of the creation of the digital vault. Once the interface component 114 has received the confirmation message, then, the interface component 114 may, at 250, display the digital vault (e.g., the contents of the digital vault) to the user 112 via the second system 110, and, at 252, the interface component 114 may send a confirmation response to the second system 110 to confirm that the digital vault for the entity 106 has been created.

FIGS. 2A, 2B and 2C illustrate only one example method for creating a digital vault 104 for an entity 106 from the second system 110 and that other example methods may be implemented to allow a digital vault for an entity 106 to be created from the second system 110. For example, in another example, instead of using a customer link party API 124 to obtain the third system identifier(s) associated with the entity 106, the digital vault management API may be configured to call a CIF (customer information file) system to obtain the third party identifier(s) associated with the entity 106. The CIF system may be configured to obtain a main identifier for the third system associated with the entity 106 based on information in the second system 110 associated with the entity 106 (e.g., Salesforce ID). In some cases, the CIF may maintain a database that comprises one or more records for each entity that the enterprise associated with the third system provides services and/or products to. For example, the database may comprise, for each entity that has a record in the second system 110, a record that links information associated with the entity 106 in the second system 110 to the main identifier for that entity. The CIF may then use the main identifier to identify the one or more third system identifiers associated with the entity 106. For example, the database may also comprise, for each main identifier, a record for each third system identifier that the corresponding entity is associated with that links the main identifier and the third system identifier. In such cases, the CIF may search for the records in the database that comprise the main identifier and a third party identifier and return to the digital vault management API all of the unique third party identifiers associated with the main identifier.

### Entity Access to Digital Vault

Referring back to FIG. 1, once a digital vault 104 for an entity 106 has been created in the first system 102, the entity 106 can access the digital vault 104 via the first system 102 (e.g., digital vault enterprise system). As described above, in some cases, the entity 106 can access the digital vault 104 via a digital vault portal 108 of the first system 102. In some cases, before the entity 106 can access the digital vault portal 108 (and thus the digital vault 104) the entity 106 may be authenticated.

As described above, in some cases, when the second system 110 forms part of, or is affiliated with, a third system 116, the entity's third system credentials may be associated with a unique identifier (e.g., MBUN) that is separate and distinct from the third system credentials and the digital vault 104 for the entity 106 is also associated with that unique identifier. In such cases, the entity 106 may be able to use their credentials for the third system 116 to login to/access the digital vault portal 108 (and thus the digital vault 104). Specifically, once the entity's third system 116 credentials have been verified by the third system 116, the third system 116 may return the unique identifier (e.g., MBUN) associated with those credentials to the digital vault portal 108. The digital vault portal 108 may then use the unique identifier (e.g., MBUN) to identify the entity's digital vault 104. Once the entity's digital vault 104 has been identified, the digital vault portal 108 may then provide the entity 106 access to their digital vault 104.

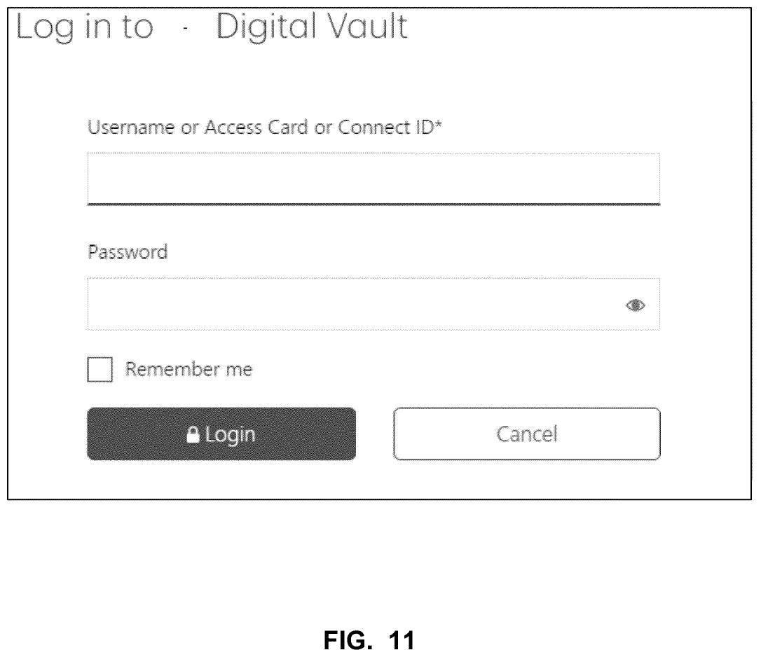

For example, when the entity 106 first accesses the digital vault portal 108, the entity 106 may be directed to a login component 130 of the digital vault portal 108 which authenticates the entity 106 by sending an authentication request to a second ping federate server 132 (which may be referred to as the customer ping federate server) of the third system 116. As described above, a ping federate server allows enterprises to securely share identity information, to provide single sign on (SSO). The second ping federate server 132 may then redirect the authentication request to a Unified Authentication Platform (UAP) server 134 in the third system 116 (e.g., enterprise computing environment). The UAP server 134 may then provide a login screen to the entity 106. FIG. 11 illustrates an example login screen which may be presented to the entity 106.

Once the entity 106 has provided their credentials to login to the third system 116 (e.g., the enterprise computing environment), the UAP server 134 may validate the provided credentials and confirm that the identified entity 106 is in fact registered for a digital vault. If the provided credentials are valid and the entity 106 is registered for a digital vault then the UAP server 134 may provide the unique identifier (e.g., MBUN) associated with the provided credentials to the digital vault portal 108 (e.g., the login component 130 thereof). The digital vault portal 108 may then identify the digital vault 104 associated with the unique identifier (e.g., MBUN) and provide the entity 106 with access to the identified digital vault 104 via, for example, a view/upload/download component 136 thereof. For example, the view/upload/download component 136 may provide a graphical user interface that allows the entity 106 to view the contents of, upload digital documents to, view digital documents in, download digital documents from, delete digital documents in, modify the metadata of digital documents in, and/or change the location of a digital document in, the digital vault 104 associated with the entity 106.

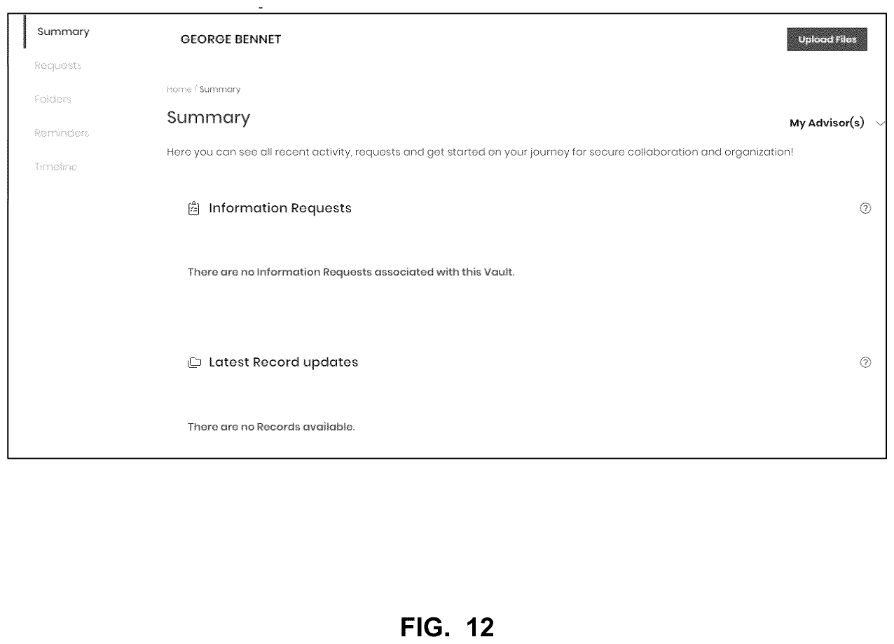

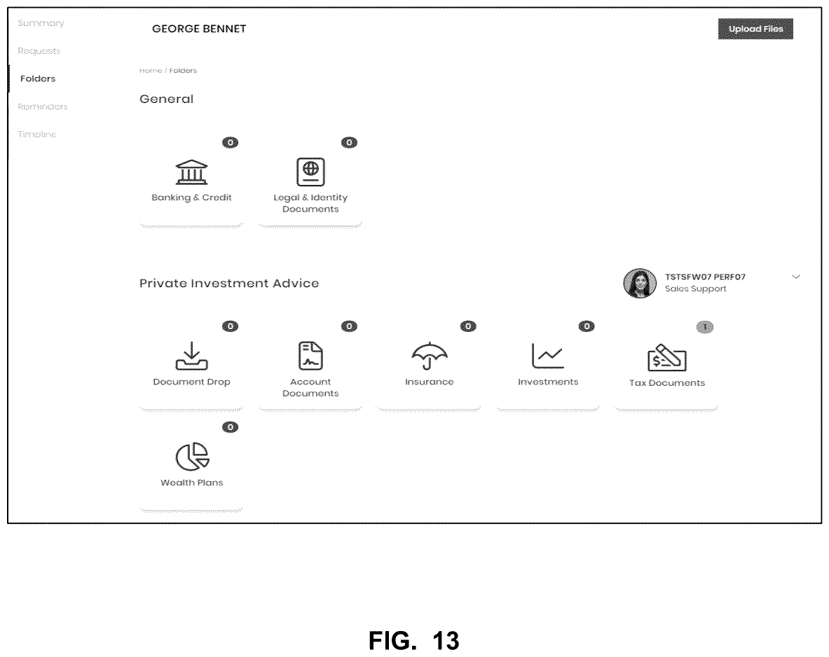

FIGS. 12 and 13 illustrate an example graphical user interface that the view/upload/download component 136 may provide to allow an entity 106 to view the contents of, upload digital documents to, view digital documents in, download digital documents from, delete digital documents in, modify the metadata of digital documents in, and/or change the location of a digital document in, the digital vault 104 associated with the entity 106. The graphical user interface shown in FIGS. 12 and 13 provides different options for viewing information related to a digital vault—Summary, Requests, Folders, Reminders, Timeline. FIG. 12 shows the graphical user interface after the entity has selected the “Summary” option, and FIG. 13 shows the graphical user interface after the entity has selected the “Folders” option. It can be seen from FIG. 13 that the “Folders” option displays the contents of the digital vault. In this example, the digital vault comprises two drawers—“General” and “Private Investment Advice”—and the digital documents in each drawer are divided into tiles. Specifically, the “General” drawer has two tiles—a “Banking and Credit” tile and a “Legal & Identity Documents” tile; and the “Private Investment Advice” drawer comprises a “Document Drop” tile, an “Account Documents” tile, an “Insurance” tile, an “Investments” tile, a “Tax Documents” tile and a “Wealth Plans” tile. The entity can view the digital documents in the tiles by clicking on the tiles. Although, it is noted that in this example the only tile that currently comprises a digital document is the “Tax Documents” tile which is denoted by the “1” in the upper right corner of the tile icon.

In some cases, the first time the entity 106 logs in to the digital vault portal the entity 106 may be asked to provide a second level of authentication information. For example, the entity 106 may be asked to provide a one-time password (OTP) sent to the entity 106 via a verified communications channel (e.g., via an email sent via a verified email address or via a text sent to a verified number).

In some cases, the first time the entity 106 logs in the digital vault portal 108 they may be provided with a list of Terms and Conditions for using the digital vault 104 and the entity 106 must accept the Terms and Conditions before they can access the digital vault 104. In some cases, any changes to the Terms and Conditions after an entity's initial acceptance of the Terms and Conditions are shared with the entity 106 via email.

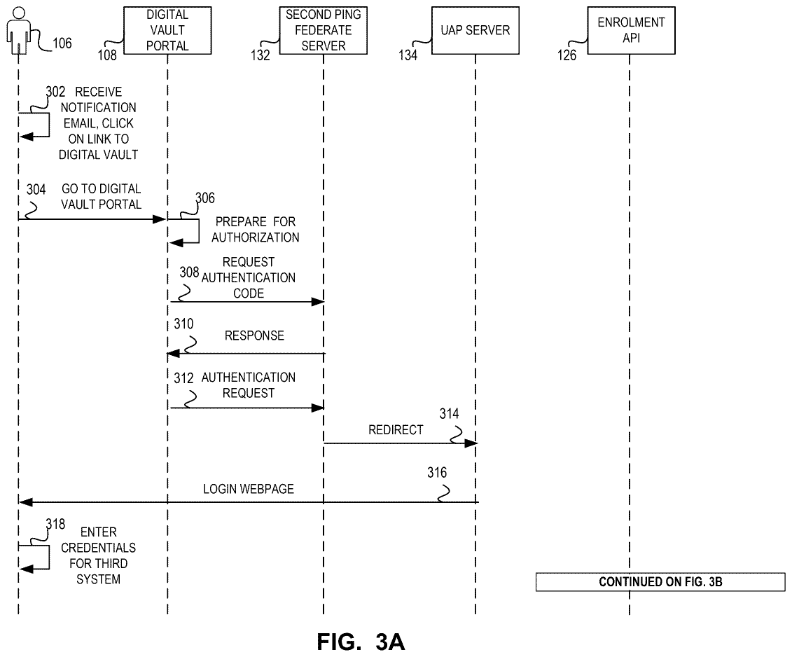

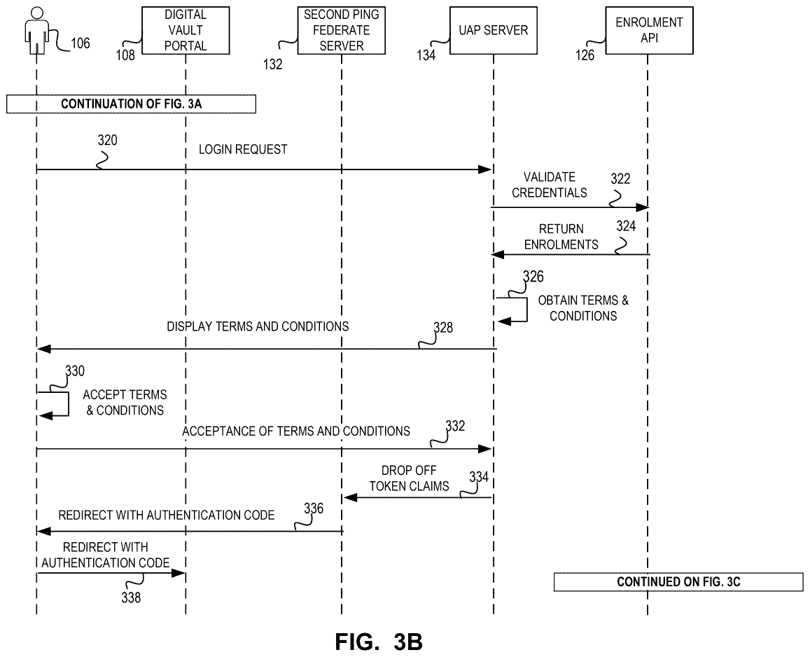

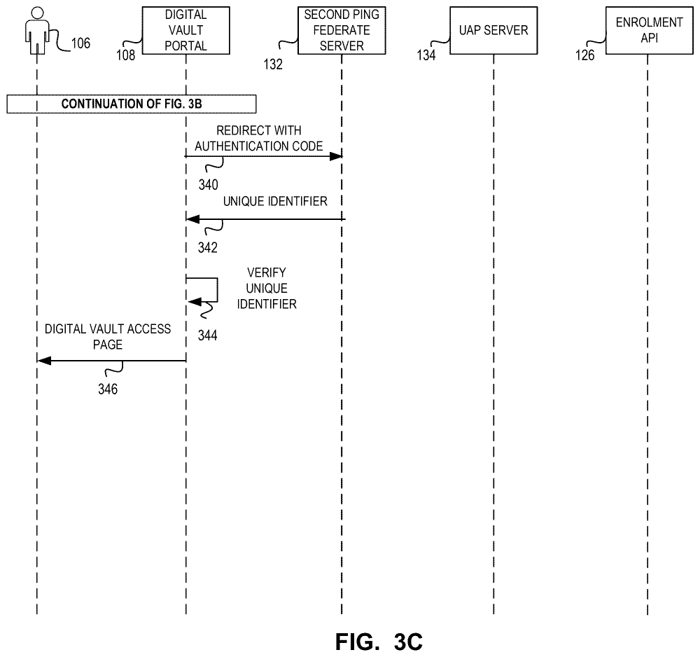

Reference is now made to FIGS. 3A, 3B and 3C which illustrate an example message flow for an entity 106 to access their digital vault 104 from the first system (e.g., via the digital vault portal 108 thereof) using credentials for the third system 116. The process begins at 302 where the entity 106 receives, e.g., via a computing device associated with the entity 106, a notification email indicating that a digital vault 104 has been created for the entity 106. The notification email may comprise a link which the entity 106 may click on or otherwise activate to access the digital vault. When the user clicks on or otherwise activates the link, at 304, the entity 106 (e.g., the computing device associated with the entity 106) is directed to the digital vault portal 108. In response to the entity 106 accessing the digital vault portal 108, the digital vault portal 108, at 306, prepares for authorization of the entity 106. Where the system 100 implements PKCE (Proof Key of Code Exchange) authorization, preparing for authorization may comprise generating a code verifier and transforming the code verifier into a code challenge. A code verifier is a random set of number and letters. The code verifier is transformed into a code challenge, using for example, a hash function or algorithm, such as, but not limited to, sha256.

Once the digital vault portal 108 has prepared for authorization (e.g., by generating a code verifier and code challenge), the digital vault portal 108, at 308, sends a request for an authentication code to the second ping federate server 132. In some cases, the request for an authentication code may be in the form of an OAuth 2.0 Published Authorization Request (PAR). A PAR allows an application to push the payloads of authorization requests to an authorization server via direct requests to a PAR endpoint. In response to receiving the authentication code request, the second ping federate server 132, at 310, sends a response that includes the uniform resource indicator (URI) and the requested authentication code. The digital vault portal 108 then, at 312, sends an authentication request to the second ping federate server 132 that identifies the URI and, at 314, the second ping federate server 132 redirects the request to the UAP server 134.

In response to receiving the redirected authentication request (at 314), the UAP server 134, at 316, sends the entity 106 (e.g., a computing device associated with the entity 106) a login webpage. Upon receiving the login webpage, the entity 106, at 318, enters their credentials for the third system 116, and then, at 320, a login request is sent from the entity 106 (e.g., a computing device associated with the entity 106) to the UAP server 134. The login request comprises the credentials for the third system 116 entered by the entity 106. The UAP server 134 then, at 322, forwards the credentials to the enrolment API 126 for validation. If the credentials are validated then the enrolment API 126, at 324, returns a list of services that the entity 106 is enrolled in. If, however, the credentials are not validated then the enrolment API 126 may return an error message to the UAP server 134 and the UAP server 134 may forward the error message to the entity 106.

If the UAP server 134 determines from the list of enrolments that the entity is registered for a digital vault and it is not the first time the entity 106 has logged into or accessed the digital vault 104 then the process may proceed to 334. If, however, the UAP server 134 determines from the list of enrolments that the entity 106 is registered for a digital vault and this is the first time the entity 106 has logged in to/accessed the digital vault 104, then the UAP server 134 may, at 326, obtain a set of terms and conditions for using the digital vault and, at 328, cause the terms and conditions to be displayed to the entity 106. The entity 106 then, at 330, accepts the terms and conditions which causes, at 332, an acceptance of the terms and conditions to be sent to the UAP server 134. In other cases, instead of the UAP server 134 receiving a set of enrolments if the user credentials are validated, the enrolment API 126 may itself determine whether the validated entity is registered for a digital vault and if so, notify the UAP server 134, and, if not, send an error message to the UAP server 134.

At 334, the UAP server 134 sends drop off token claims to the second ping federate server 132. The drop off token claims may comprise the unique identifier (e.g., MBUN) associated with the credentials provided by the entity 106 and other information such as, but not limited to, the authentication method reference, state and nonce. Upon receiving the message at 334, the second ping federate server 132, at 336, sends a redirection to the entity 106 (e.g., a computing device associated with the entity 106) along with the authentication code received at 310. In response to receiving the redirection, the entity 106 (e.g., a computing device associated with the entity 106), at 338, sends the redirection with the authentication code to the digital vault portal 108. This causes the digital vault portal 108 to, at 340, send the authentication code to the second ping federate server 132 for authentication. If the second ping federate server 132 authenticates the authentication code, the second ping federate server 132, at 342, sends the digital vault portal 108 the unique identifier (e.g., MBUN) associated with the credentials provided by the entity 106. The digital vault portal 108 then, at 344, determines whether the unique identifier received at 342 is valid (e.g., there is a digital vault associated with the unique identifier). If the digital vault portal 108 determines that the unique identifier received at 342 is valid, the digital vault portal 108 identifies the digital vault associated with the unique identifier and, at 346, provides the entity 106 with a webpage to access the identified digital vault. From the digital vault access page, the entity 106 may be able to view the contents of, upload digital documents to, view digital documents in, download digital documents from, deleted digital documents in, modify the metadata of digital documents in, and/or change the location of a digital document in, the digital vault 104.

FIGS. 3A, 3B and 3C illustrate only one example method of how an entity 106 may access their digital vault 104 from the first system 102 using credentials for the third system 116 and that other example methods may be implemented to allow the entity 106 to access their digital vault 104 from the first system 102 using credentials for the third system 116.

### User of Second System Uploading a Digital Document to a Digital Vault

Referring back to FIG. 1, once the digital vault 104 for an entity 106 has been created, a user 112 of the second system 110 may be able to add or upload digital documents to the digital vault 104 via the second system 110. In some cases, a user 112 of the second system 110 may be able to add or upload digital documents to the digital vault 104 even before the entity 106 has logged in to the digital vault and/or accepted the Terms and Conditions.

In some cases, a user 112 of the second system 110 may upload digital documents to the digital vault 104 from the second system 110 by first opening or accessing the record in the second system 110 associated with the entity 106. In some cases, a user 112 may be able to open the record in the second system 110 associated with an entity 106 by searching for the entity 106 in a list of entities in the second system 110, and then selecting the entity 106. For example, once the user 112 has selected the entity 106, the second system 110 may present a graphical user interface to the user 112 that allows the user 112 to view and interact with the entity's record.

If the user 112 is authorized to access the entity's digital vault 104, then the interface component 114 may provide the user 112 with an option to view the selected entity's digital vault. For example, if the user 112 is authorized to access the entity's digital vault 104 the interface component 114 may display a “Digital Vault” link or tab in the graphical user interface which the user 112 can click on or otherwise activate.

If the user 112 indicates they wish to view the selected entity's digital vault (e.g., by clicking on or otherwise activating the “Digital Vault” link or tab), the interface component 114 may send the first system 102 information from the second system 110 that identifies the selected entity 106; and request information about the contents of the digital vault associated with the provided information. The information from the second system 110 that identifies the entity may be a user identifier (ID) in the second system 110 (e.g., an identifier associated with the entity 106 in the second system 110). For example, where the second system 110 is a Salesforce™ system the information identifying the entity 106 may the entity's Salesforce™ ID. In contrast to the first system 102, the second system 110 may not be able to obtain information from the third system 116 identifying the entity 106 (e.g., the unique identifier (e.g., MBUN)) associated with the entity 106), so the second system 110 may use information from the second system 110 to identify the entity 106 and thus the digital vault associated with the entity 106.

Once the first system 102 (e.g., first system API 120) has identified the digital vault associated with the entity 106 from the information from the second system 110, the first system 102 (e.g., first system API 120) may obtain information about the contents of the digital vault (e.g., a list of the digital documents in the digital vault) and provide that information to the interface component 114. The interface component 114 may then display that information to the user 112. For example, the interface component 114, may receive a list of the contents of the digital vault and the interface component 114 may display, via, for example, a graphical user interface (GUI), the list to the user 112.

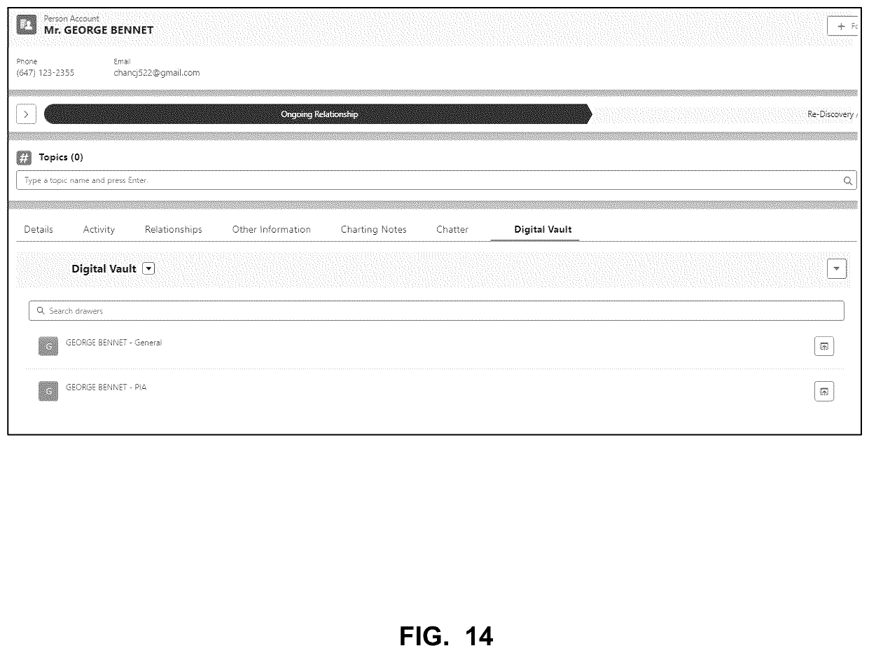

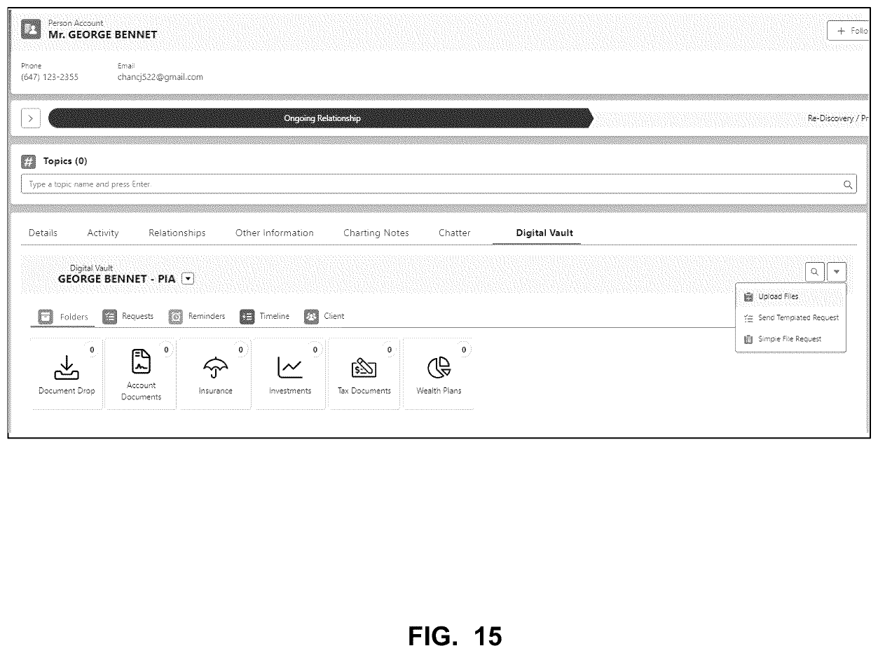

FIGS. 14 and 15 illustrate an example graphical user interface which may be presented to the user 112 by the second system 110 and the interface component 114 for interacting with the digital vault associated with an entity. FIGS. 14 and 15 show a graphical user interface after the user has accessed an entity (“George Bennet”) record in the second system and selected the “Digital Vault” option (which was added to the standard graphical user interface for the second system by the interface component). FIG. 14 shows the graphical user interface after the user has selected the “Digital Vault” option. Specifically, FIG. 14 shows the drawers of George Bennet's digital vault. In particular, George Bennet's digital vault comprises a “General” drawer and a “PIA” drawer. The user can view the contents of a drawer by clicking on the drawer. FIG. 15 shows the graphical user interface of FIG. 14 after the user has selected the “PIA” drawer of the digital vault. Specifically, FIG. 15 shows the tiles in the “PIA” drawer—specifically, there is a “Document Drop” tile, an “Account Documents” tile, an “Insurance” tile, an “Investments” tile, a “Tax Documents” tile and a “Wealth Plans” tile.

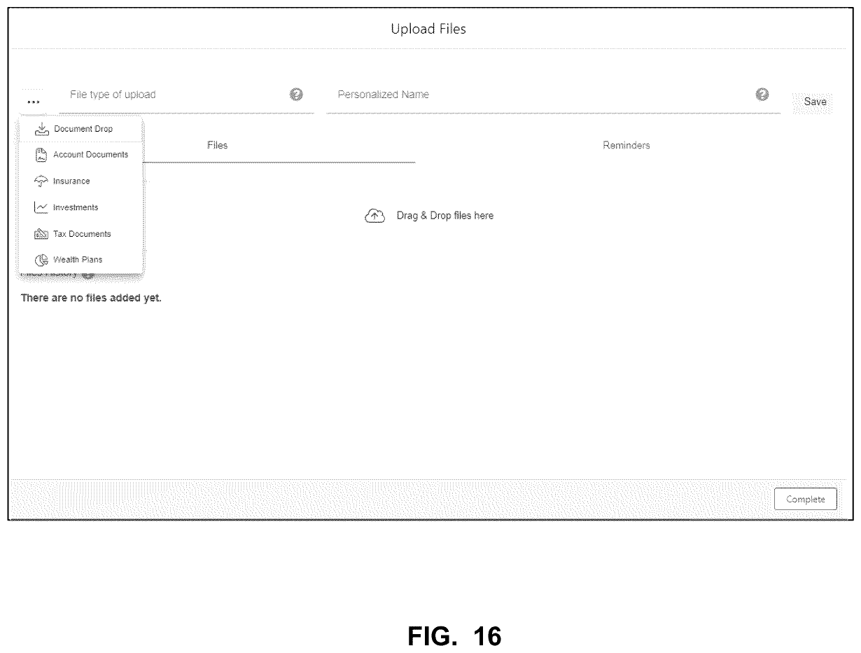

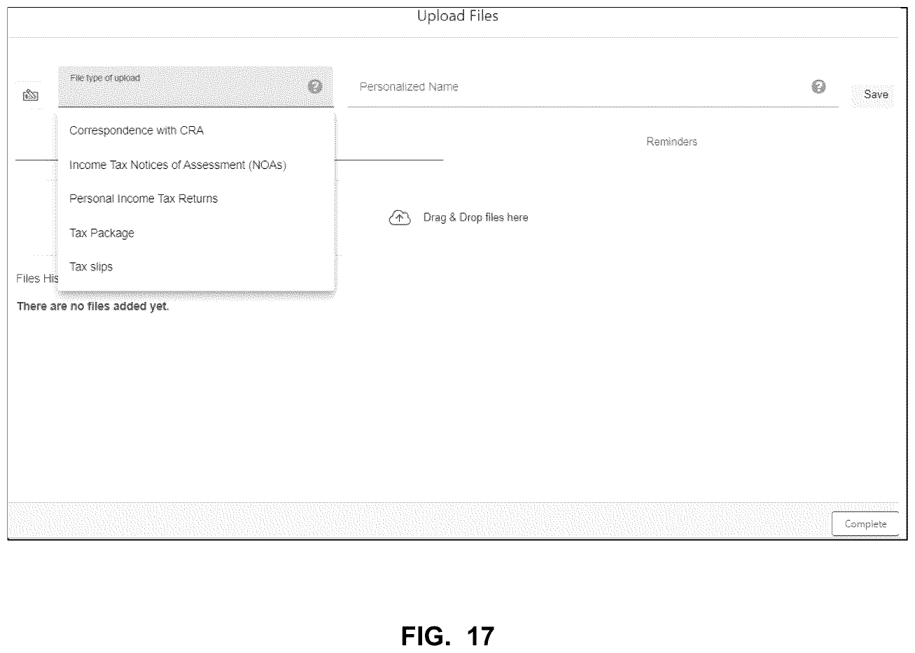

The user 112 may then indicate, using for example, the graphical user interface, that they wish to add a digital document to the digital vault 104. For example, in the graphical user interface shown in FIG. 15, the user can indicate they wish to add a digital document to the digital vault by selecting the down arrow on the right hand side of the GUI and selecting “Upload File”. This may cause an upload file interface, such as that shown in FIGS. 16 and 17 to be displayed to the user. Once the upload file interface is displayed, the user can (i) as shown in FIG. 16, select which tile the digital document is to reside; (ii) as shown in FIG. 17, select which folder (of the selected tile), the digital document is to reside; and (iii) provide the digital document (e.g., by dragging and dropping the document into the upload file interface).

Once the user has indicated that that wish to add a specific digital document to the digital vault 104, the interface component 114 uploads the specified digital document to the digital vault 104 via the first system 102. In some cases, the first system 102 may then notify the entity 106 (e.g., via email) that a new document has been uploaded to the digital vault 104. The first system 102 may also, or alternatively, notify the interface component 114 that the digital document was successfully uploaded to the digital vault 104, which may cause the interface component 114 to display a corresponding message to the user 112, via, for example, the GUI.

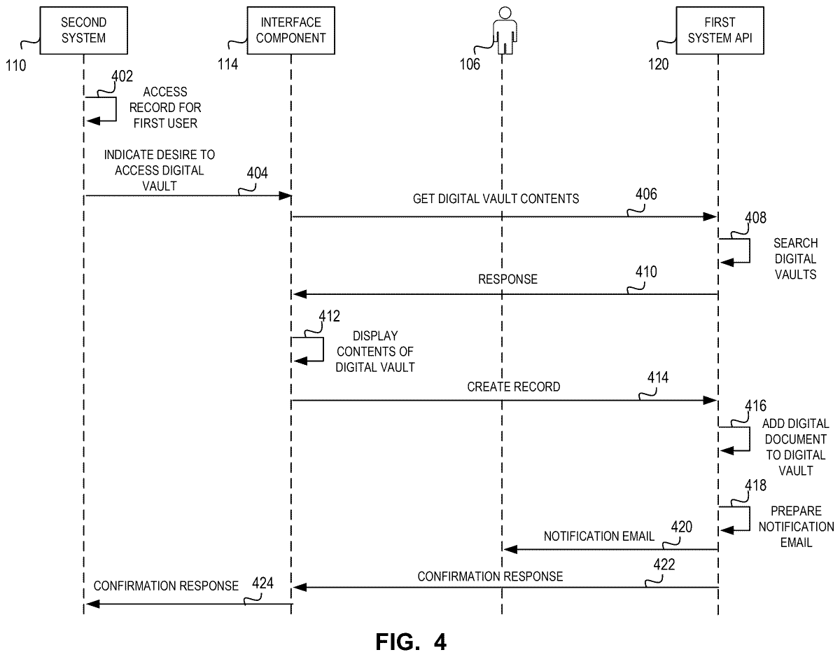

Reference is now made to FIG. 4 which illustrates an example message flow for uploading a digital document to a digital vault 104 for an entity 106 from the second system 110. The process begins at 402 where a user 112 of the second system 110 accesses the record in the second system 110 for the entity 106. For example, as described above, the user 112 may access the record in the second system 110 by performing a search in the second system 110 for the entity 106 and, once located, selecting the entity 106. Once the user 112 has accessed the record in the second system 110 for the entity 106, the user 112, at 404, indicates their desire to access the entity's digital vault. For example, as described above, the interface component 114 may present a “Digital Vault” link or tab in a graphical user interface of the second system 110, and the user 112 may be able to indicate they wish to access the digital vault associated with the currently selected entity/record by selecting or otherwise activating the “Digital Vault” link or tab.

In response to receiving the indication from the user 112 that they wish to access the digital vault associated with the currently selected entity/record, the interface component 114, at 406, sends a get digital vault contents request to the first system 102 (e.g., first system API 120). The get digital vault contents request comprises information from the second system 110 identifying the entity 106 and thus the digital vault to be accessed. As noted above, the information from the second system 110 identifying the entity 106 may comprise an identifier in the second system 110 associated with the entity 106. The get digital vault contents request may also comprise other information such as, but not limited to, contact information for the entity 106 (e.g., an email address) and/or other information about the entity 106.

In response to receiving the get digital vault contents request, the first system 102 (e.g., the first system API 120), at 408, identifies the digital vault associated with the provided information, determines the contents of the identified digital vault and, at 410, sends a response to the interface component 114 that comprises information identifying the identified digital vault (e.g., a digital vault ID and/or a filing cabinet ID) and information identifying the contents of the digital vault. Then, at 412, the interface component 114 displays the contents of the digital vault to the user 112 (e.g., via a graphical user interface). In some cases, the interface component 114 may be configured to only temporarily store the information identifying the digital vault (e.g., digital vault ID and/or filing cabinet ID).

Once the contents of the digital vault have been displayed to the user 112, the user 112 may indicate to the interface component 114 that they want to add a digital document to the digital vault (e.g., by dragging and dropping a digital document into the contents of the digital vault). This may trigger the interface component 114 to, at 414, send a create record request to the first system 102 (e.g., first system API 120). The create record request comprises information identifying the digital vault (e.g., digital vault ID and/or filing cabinet ID) and the digital document. In response, to receiving the create record request, the first system 102 (e.g., first system API 120), at 416, uploads the received digital document to the identified digital vault.

In some cases, as shown in FIG. 4, if the received digital document is successfully uploaded to the digital vault, the first system 102 (e.g., first system API 120) may, at 418, prepare a notification email for the entity 106 to notify the entity 106 that a new digital document has be uploaded to their digital vault, and at 420, send the notification email to the entity 106. The notification email may, for example, include information indicating the digital document that has been added to the digital vault, and/or a link to the digital vault.

If the received digital document is successfully uploaded to the digital vault, the first system 102 may, at 422, send a confirmation response to the interface component 114 that confirms that the digital document was successfully uploaded. This may cause the interface component 114, at 424, to send a confirmation response to the second system 110.

FIG. 4 illustrates only one example method of how a digital document can be uploaded to a digital vault 104 in the first system 102 via the second system 110, and other example methods may be implemented to allow a digital document to be uploaded to a digital vault 104 in the first system 102 via the second system 110.

### Requesting Digital Documents From Entity

In some cases, a user 112 of the second system 110 may be able to cause, from the second system 110, a digital document request to be sent to an entity 106 which ask the entity 106 to upload one or more documents to their digital vault 104. In some cases, the user 112 may be able to select from a predetermined list of documents or manually identify the document to be uploaded.

In some cases, a user 112 may be able to make one of a plurality of digital document request types. The plurality of digital document request types may comprise one or more of: simple file request, simple questionnaire request, topic specific information request and checklist request. A simple request may request that the entity 106 upload a specific document (e.g., driver's license) to the digital vault 104. The specific document may be selected from a predetermined list of documents. A simple questionnaire request may be a request for the entity to answer a list of one or more questions. The questions may be selected from a predetermined list of questions. A topic specific information request may be a request for the entity to answer a predetermined set of questions and upload a set of one or more documents to address a specific topic. While the set of questions and documents for a topic may be predetermined the user 112 may be able to remove questions and documents from the request prior to sending to the entity. A checklist may comprise a list of actions/document that the entity is to track and once an action is completed information is sent back to the user 112 confirming completion. Answers to a set of questions or confirmation that a task has been completed may be stored in the associated digital vault as unencrypted or encrypted data. Such data may be referred to herein as a digital document.

In some cases, a user 112 may be able to associate a digital document request with a due date and/or reminders and the first and/or second system 110 may be configured to send a message to the entity if the due date is missed and/or a reminder time and/or date has been reached.

### Related Entities and Consolidated Mode

In some cases, multiple entities may be affiliated in the second system 110. For example, the second system 110 may be used to provide a single product or service to multiple entities—e.g., entities that reside at the same address, or entities that have a familial relationship. Where multiple entities 106 are affiliated in the second system 110 and each of those entities is associated with their own digital vault 104 then those digital vaults may be referred to as affiliated digital vaults. A user 112 of the second system 110 may be able to interact, via the interface component 114, with affiliated digital vaults in individual mode or consolidated mode. In individual mode, a user 112 can view and interact with one of the affiliated digital vaults at a time. For example, if Bob Smith and George Smith are affiliated in the second system 110, in individual mode a user 112 can view and interact with a single affiliated vault at a time—e.g., either Bob Smith's digital vault or George Smith's digital vault. In contrast, in consolidated mode a user 112 of the second system 110 may be able to interact with all affiliated digital vaults at the same time. For example, in consolidated mode a user 112 may be able to view the contents of both Bob Smith's digital vault and George Smith's digital vault at the same time as if they are a single consolidated digital vault. When a user 112 is viewing and interacting with affiliated digital vaults in consolidated mode, adding a digital document to the consolidated vault may automatically add the digital document to each affiliated digital vault. In contrast, when a user 112 is viewing and interacting with affiliated digital vaults in individual mode, adding a copy of the digital document to an individual vault may only add the digital document to the digital vault that is currently being viewed.

### Methods

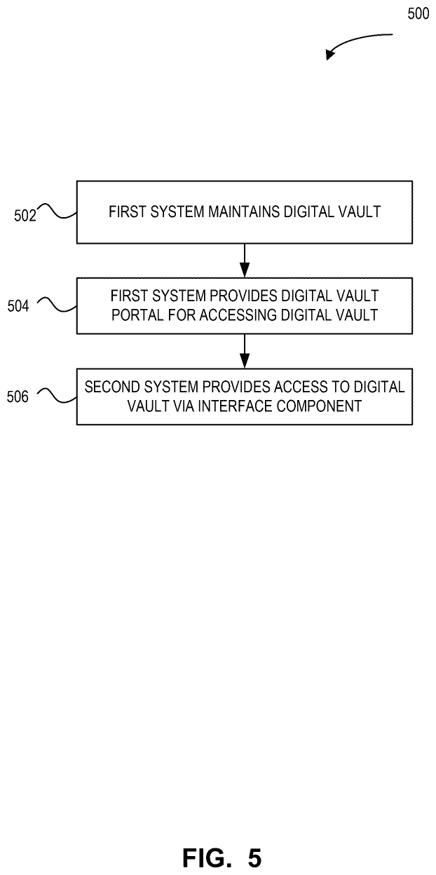

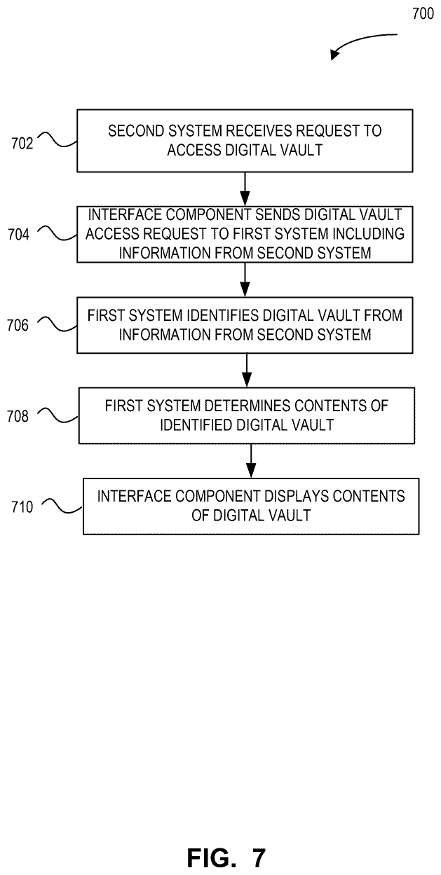

Reference is now made to FIG. 5 which illustrates an example method 500 for sharing digital documents using a digital vault. The method 500 begins at block 502 where a first system (e.g., first system 102) maintains a digital vault (e.g., digital vault 104) for storing one or more digital documents. In one example, the first system may be a system implemented and maintained by a digital vault enterprise, such as, but not limited to, SideDrawer™. The digital vault (e.g., digital vault 104) may be associated with an entity (e.g., a client or customer). At block 504, the first system (e.g., first system 102) provides a digital vault portal (e.g., digital vault portal 108) for accessing the digital vault. In some cases, the digital vault portal (e.g., digital vault portal 108) may be designed to allow an entity (e.g., entity 106) to access its own digital vault. FIG. 7 illustrates an example method of how an entity (e.g., entity 106) may access their digital vault using the digital vault portal. At block 506, a second system (e.g., second system 110) that is separate and distinct from the first system, provides access to the digital vault (e.g., digital vault 104) via an interface component that interfaces between the first system and the second system. In some cases, the second system (e.g., second system 110) maintains a record for each of one or more entities and the digital vault is associated with one of the one or more entities. In some cases, the second system (e.g., second system 110) may be a Salesforce™ system. In such cases, the interface component may be a lightening web component that is integrated into the second system. However, this is just an example. FIG. 5 illustrates an example order of the blocks 502, 504, 506 of the method 500. However, this is just an example and in other examples, the blocks may be executed in a different order. For example, in other examples any combination of blocks 502, 504, 506 may be executed in parallel.

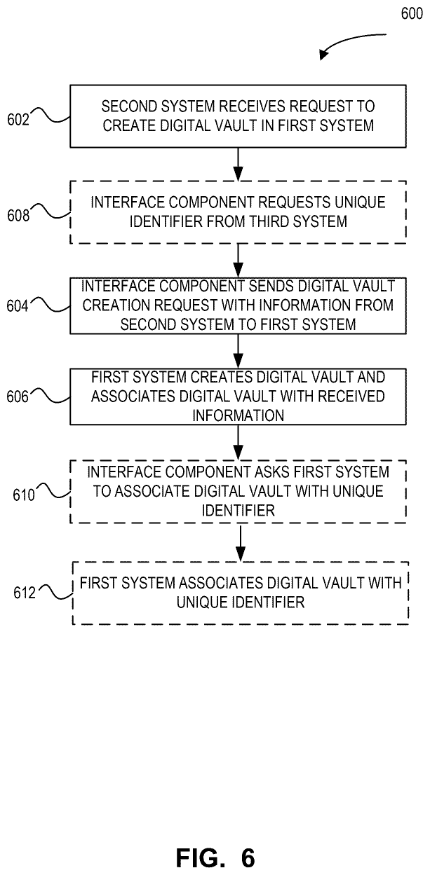

Reference is now made to FIG. 6 which illustrates an example method 600 for creating a digital vault in the first system from the second system (via the interface component). The method 600 begins at block 602 where the second system (e.g., second system 110) receives a request to create a digital vault in the first system (e.g., first system 102) for an entity. As described above, in some cases, the second system (e.g., a second system 110) may receive a request to create a digital vault in response to a user (e.g., user 112) of the second system accessing, via, for example, a graphical user interface, the record in the second system associated with the entity, and then selecting or activating a “create digital vault” link, button or the like. Once the second system 110 has received a request to create a digital vault in the first system for an entity, the method proceeds to block 604.

At block 604, the interface component 114 sends a request to the first system (e.g., an API of the first system) to create a digital vault for the entity. The request to create the digital vault comprises information from the second system 110 that is associated with the entity. In some cases, the information from the second system may comprise an identifier that is associated with the entity. For example, where the second system is a Salesforce™ system, the information may comprise a Salesforce™ ID associated with the entity. Once the request has been sent to the first system, the method proceeds to block 606.

At block 606, in response to receiving the request to create the digital vault for the entity, the first system (e.g., first system 102) creates a digital vault for the entity and associates the digital vault with the information from the second system associated with the entity. Associating the digital vault with the information from the second system associated with the entity allows the second system (via the interface component) to identify and access the digital vault associated with the entity from information accessible to the second system. This means that the second system does not have to store additional information about the digital vault, such as, but not limited, a unique digital vault identifier, to allow a user to access the digital vault from the second system. Once the digital vault is created the first entity may send a confirmation to the interface component that the vault was created. The confirmation may include information identifying the digital vault such as, but not limited, to a digital vault identifier.

In some cases, the second system may form part of, or be affiliated with, a third system. For example, the third system may be an enterprise computing environment wherein the enterprise provides one or more products or services to clients and the second system may be used to provide one of the one or more products or services to clients. In such cases, the entities of the second system may be clients of the third system. In these cases, the method 600 may further comprise blocks 608, 610, 612. At block 608 the interface component obtains from the third system a unique identifier (e.g., MBUN) associated with the entity, at block 610 the interface component sends a request to the first system to associate the digital vault with the unique identifier from the third system (the request may comprise information identifying the digital vault such as, but not limited to, the digital vault identifier received from the first system), and block 612 where the first system, in response to the request, associates the digital vault with the unique identifier from the third system.

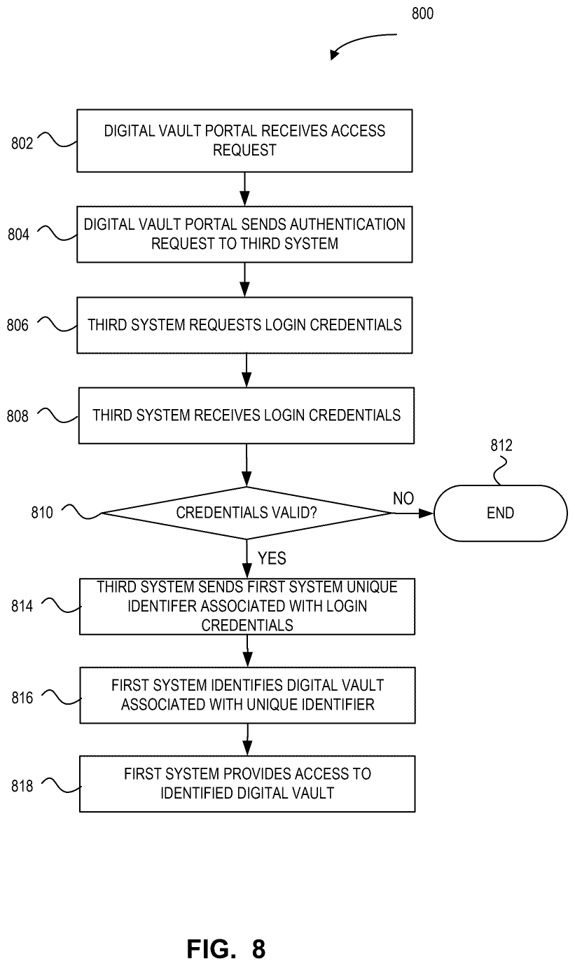

As described above, in some cases the unique identifier may be generated by the third system specifically for the purpose of linking the digital vault to the entity's record in the third system. Specifically, by associating the entity in the third system with the unique identifier and associating the digital vault with the unique identifier, the unique identifier links the entity in the third system with the digital vault. This may allow the entity to access the digital vault (via the digital vault portal) using its credentials for the third system without having to provide confidential information from the third system, such as, a main identifier in the third system or login credentials from the third system, to the first system. For example, as described with respect to FIG. 8, the entity may be able to login to the first system using its third system credentials and, once authenticated using those credentials, the third system may provide the unique identifier to the first system. The first system can then use the unique identifier to identify the digital vault associated with that entity.

FIG. 6 illustrates an example order of the blocks 602, 604, 606, 608, 610 and 612, however in other examples, the blocks 602, 604, 606, 608, 610, 612 may be executed in a different order.

Reference is now made to FIG. 7 which illustrates an example method 700 for accessing a digital vault from the second system. The method 700 begins at block 702 where the second system receives a request to access a digital vault associated with an entity. In some cases, the request may be caused by a user of the second system accessing a record in the second system associated with the entity and then indicating that they wish to access a digital vault associated with that entity. In some cases, a user may only be able to make such a request if (a) they have permission to access the entity's record; and (ii) they have permission to access digital vaults. In some cases, permission to access an entity's record may be controlled by RR codes within the second system and permission to access digital vaults may be controlled by active directory groups in the third system. Once the second system receives a request to access a digital vault associated with an entity, the method 700 proceeds to block 704.

At block 704, in response to the request, the interface component sends a digital vault access request to the first system (e.g., an API of the first system). The request comprises information from the second system associated with the entity (e.g., the information from the second system that was sent to the first system when the digital vault was generated). Once the request has been sent, the method 700 proceeds to block 706.

At block 706, the first system identifies the relevant digital vault from the information from the second system associated with the entity and obtains a list of the contents of the identified digital vault (and the organization thereof, if organized into drawers, folders etc.); and at block 708 the first system sends the interface component a list of the contents of the identified digital vault (and the organization thereof, if organized into drawers, folder etc.). The method 700 then proceeds to block 710.

At block 710, the interface component display the contents of the digital vault (and the organization thereof, if organized into drawers, folders etc.). In some cases, if the user is only authorized (or has permission) to access a portion of the digital vault (e.g., a drawer thereof) then only that portion of the digital vault may be displayed to the user. Once all or a portion of the contents of the digital vault are displayed to the user, the user can interact with the digital vault, via the interface component to view, download, upload etc., digital documents in/to the digital vault.

Reference is now made to FIG. 8 which illustrates an example method 800 for accessing a digital vault in the first system from the digital vault portal when the second system is part of, or is affiliated with, a third system. As described above, in some cases, the digital vault portal may be designed to provide access to digital vaults for entities associated with the digital vaults. The example method 800 begins at block 802 where the digital vault portal receives an access request. Once the access request has been received, the method 800 proceeds to block 804 where the digital vault portal sends an authentication request to the third system. As described above, in some cases, the digital vault portal may send the authentication request to a ping federate server in the first system which forwards the request to a UAP server in the third system. The method 800 then proceeds to block 806.

At block 806, the third system (e.g., UAP server of the third system) requests login credentials for the third system. At block 808, the third system receives login credential in response to the request. At block 810, the third system determines whether the received login credentials are valid (and optionally that the digital vault portal is itself authenticated). If the login credentials are not valid then the method 800 ends 812. If, however, the login credentials are valid then the method proceeds to block 814 where the third system (e.g., UAP server of the third system) obtains (e.g., via an enrolment API of the third system) a unique identifier associated with the logic credentials and provides the unique identifier to the first system. The method 800 then proceeds to block 816.

At block 816, the digital vault portal identifies the digital vault associated with the unique identifier received from the third system and at block 818 provides access to the digital vault (e.g., presents a digital vault access page).

### Example Computer

Reference is now made to FIG. 9 which illustrates a simplified block diagram of an example computer 900. Computer 900 is an example implementation of a computer which may implement all or a part of the system 100 of FIG. 1 and/or all or a part of the method 500 of FIG. 5, the method 600 of FIG. 6, the method 700 of FIG. 7 and/or the method 800 of FIG. 8. For example, computer 900 may implemented all or a part of the first system 102, the second system 110 and/or the third system 116. Computer 900 has at least one processor 902 operatively coupled to at least one memory 904, at least one communications interface 906 (also referred to herein as a network interface), and at least one input/output (I/O) device 908.

The at least one memory 904 includes a volatile memory that stores instructions executed or executable by the processor 902, and input and output data used or generated during execution of the instructions. The memory 904 may also include non-volatile memory used to store input and/or output data—e.g., within a database—along with program code containing executable instructions.

The processor 902 may transmit or receive data via the communications interface 906 and may also transmit or receive data via any additional input/output device 908 as appropriate.

In some cases, the processor 902 may include a system of central processing units (CPUs) 910. In other cases, the processor 902 includes a system of one or more CPUs 910 and one or more Graphical Processing Units (GPUs) 912 that are coupled together.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A computing system for sharing digital documents, the system comprising:
a first system comprising:
a digital vault for storing one or more digital documents, and
a digital vault portal that provides access to the digital vault;
a second system that is separate and distinct from the first system; and
an interface component that interfaces between the first system and the second system to provide access to the digital vault from the second system.

2. The system of claim 1, wherein the interface component is configured to:
receive, via the second system, a request to create the digital vault; and
in response to receiving the request to create the digital vault, cause the first system to create the digital vault.

3. The system of claim 2, wherein the interface component is configured to, prior to causing the first system to create the digital vault, obtain a unique identifier from a third system, and causing the first system to create the digital vault comprises causing the first system to associate the digital vault with the unique identifier.

4. The system of claim 3, wherein, the digital vault portal is configured to:
receive a request to access the digital vault; and
in response to receiving the request to access the digital vault:
request login credentials,
receive login credentials in response to the request,
send the received login credentials to the third system,
in response to the login credentials being verified by the third system, receive, from the third system, the unique identifier, and
identify the digital vault from the unique identifier.

5. The system of claim 3, further comprising the third system.

6. The system of claim 5, wherein the third system is an enterprise computing environment.

7. The system of claim 3, wherein the digital vault is associated with an entity, and the interface component is configured to, prior to causing the first system to create the digital vault, cause the third system to record that the entity is associated with the digital vault.

8. The system of claim 7, wherein the interface component is configured to cause the third system to record that the entity is associated with the digital vault by interacting with one or more application programming interfaces of the third system.

9. The system of claim 2, wherein causing the first system to create the digital vault comprises obtaining information from the second system associated with the digital vault and causing the first system to associate the digital vault with the information from the second system.

10. The system of claim 9, wherein:
the interface component is configured to:
receive, via the second system, a request to access the digital vault, the request comprising the information from the second system associated with the digital vault, and
send the information from the second system associated with the digital vault to the first system; and
the first system is configured to:
identify the digital vault based on the received information from the second system associated with the digital vault, and
send the interface component information identifying the one or more digital documents in the digital vault.

11. The system of claim 1, wherein the second system is configured to grant a requestor access to a record in the second system associated with the digital vault if the requestor has a first set of permissions, and grant the requestor access to the digital vault, via the interface component, only if the requestor has the first set of permissions and a second set of permissions.

12. The system of claim 11, wherein the requestor is deemed to have the second set of permissions if the requestor belongs to one of one or more predetermined active directory groups.

13. The system of claim 12, where the second system is configured to grant the requestor access to the second system after the requestor has been authenticated by an authentication system in a third system, and in response to authenticating the requestor, the authentication system is configured to provide the second system with a list of active directory groups to which the requestor belongs.

14. The system of claim 11, wherein the requestor is deemed to have the first set of permissions if the requestor is assigned, in the second system, a registered representative code that is associated with the record.

15. The system of claim 1, wherein the first system comprises one or more application programming interfaces (APIs) and the interface component is configured to interact with at least one of the one or more APIs to provide access to the digital vault from the second system.

16. The system of claim 1, wherein the first system is a digital vault enterprise system, the second system is a Salesforce system, and the interface component is a lightening web component.

17. The system of claim 1, wherein the second system is configured to generate a digital document and, in response to receiving a request to upload the digital document to the digital vault, upload the digital document to the digital vault via the interface component.

18. The system of claim 1, wherein the interface component is configured to receive, via the second system, a request for an entity associated with the digital vault to upload a digital document to the digital vault, and in response to receiving the request, cause the first system to notify the entity of the request.

19. A method of sharing digital documents, the method executed in a computing system, and the method comprising:
maintaining, at a first system in the computing system, a digital vault that comprises one or more digital documents;
providing, at the first system, a digital vault portal for accessing the digital vault; and
providing, from a second system of the computing system that is separate and distinct from the first system, access to the digital vault via an interface component that interfaces between the first system and the second system.

20. A non-transitory computer readable medium storing computer executable instructions which, when executed by at least one computer processor, cause the at least one computer processor to carry out a method for sharing digital documents, the method comprising:
maintaining, at a first system, a digital vault that comprises one or more digital documents;
providing, at the first system, a digital vault portal for accessing the digital vault; and
providing, from a second system that is separate and distinct from the first system, access to the digital vault via an interface component that interfaces between the first system and the second system.
